(19) United States
(12) Patent Application Publication
(10) Pub. No.: US 2023/0130389 A1
(43) Pub. Date: Apr. 27, 2023

(54) SERVER, AI ETHICS COMPLIANCE CONFIRMATION SYSTEM, AND RECORDING MEDIUM

(71) Applicant: TOYOTA JIDOSHA KABUSHIKI KAISHA, Toyota-shi Aichi-ken (JP)

(72) Inventors: Daiki Yokoyama, Gotemba-shi Shizuoka-ken (JP); Tomohiro Kaneko, Mishima-shi Shizuoka-ken (JP)

(73) Assignee: TOYOTA JIDOSHA KABUSHIKI KAISHA, Toyota-shi Aichi-ken (JP)

(21) Appl. No.: 17/971,856

(22) Filed: Oct. 24, 2022

(30) Foreign Application Priority Data
Oct. 26, 2021 (JP) 2021-175018

(51) Int. Cl. G06N 20/00

(52) U.S. Cl. CPC G06N 20/00

(57) ABSTRACT

A server includes a processor that: acquires a learning condition for newly generating a learned model; identifies AI ethics that the learned model needs to satisfy; and determines whether the learned model newly generated satisfies the AI ethics based on the learning condition and the AI ethics.

### CROSS-REFERENCE TO RELATED APPLICATION(S

The present application claims priority to and incorporates by reference the entire contents of Japanese Patent Application No. 2021-175018 filed in Japan on Oct. 26, 2021.

### BACKGROUND

The present disclosure relates to a server, an AI ethics compliance confirmation system, and a recording medium.

Japanese Laid-open Patent Publication No. 2021-96771 discloses a model diagnosis device that diagnoses whether a learned neural network (NN) model newly generated in a vehicle has abnormality by performing statistical processing on a value of an output parameter output from the newly generated learned NN model.

Meanwhile, with the spread of artificial intelligence (AI), there arises a concern that discrimination due to race, gender, or the like occurs in a determination result provided by AI. AI ethics are thus being designed worldwide so that discrimination does not occur in the determination result provided by AI. Moreover, AI ethics may be different in countries, companies, and the like.

### SUMMARY

There is a need for providing a server, an AI ethics compliance confirmation system, and a recording medium storing a program capable of determining whether, for example, an AI including a neutral network model appropriately complies with AI ethics.

According to an embodiment, a server includes a processor that: acquires a learning condition for newly generating a learned model; identifies AI ethics that the learned model needs to satisfy; and determines whether the learned model newly generated satisfies the AI ethics based on the learning condition and the AI ethics.

According to an embodiment, an AI ethics compliance confirmation system includes: a device including a first processor that generates a learned model based on a learning condition; and a server that communicates with the device. Further, the server includes a second processor that: acquires the learning condition; identifies AI ethics that the learned model needs to satisfy; and determines whether the learned model newly generated satisfies the AI ethics based on the learning condition and the AI ethics.

According to an embodiment, a non-transitory computer-readable recording medium storing a program causing a processor to execute: acquiring a learning condition for newly generating a learned model; identifying AI ethics that the learned model needs to satisfy; and determining whether the learned model newly generated satisfies the AI ethics based on the learning condition and the AI ethics.

### BRIEF DESCRIPTION OF THE DRAWINGS

FIG. 1 illustrates a schematic configuration of an AI ethics compliance confirmation system according to one embodiment;

FIG. 2 is a block diagram illustrating a functional configuration of the AI ethics compliance confirmation system according to one embodiment; and

FIG. 3 is a flowchart illustrating a processing sequence in a device and a server according to one embodiment.

### DETAILED DESCRIPTION

In Japanese Laid-open Patent Publication No. 2021-96771 described above, however, no consideration is given to a method of determining whether AI or the like including a neural network model appropriately complies with AI ethics. A technique capable of determining whether newly generated AI complies with AI ethics is desired.

A server, an AI ethics compliance confirmation system, and a recording medium according to an embodiment of the present disclosure will be described below with reference to the drawings. Note that the following embodiment does not limit the present disclosure. Furthermore, the same sign is attached to the same part in the following description.

Schematic Configuration of AI Ethics Compliance Confirmation System

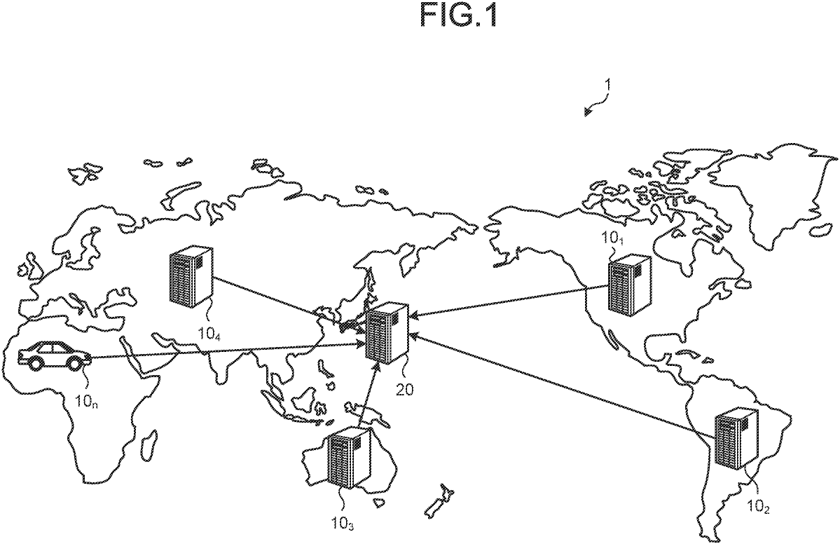

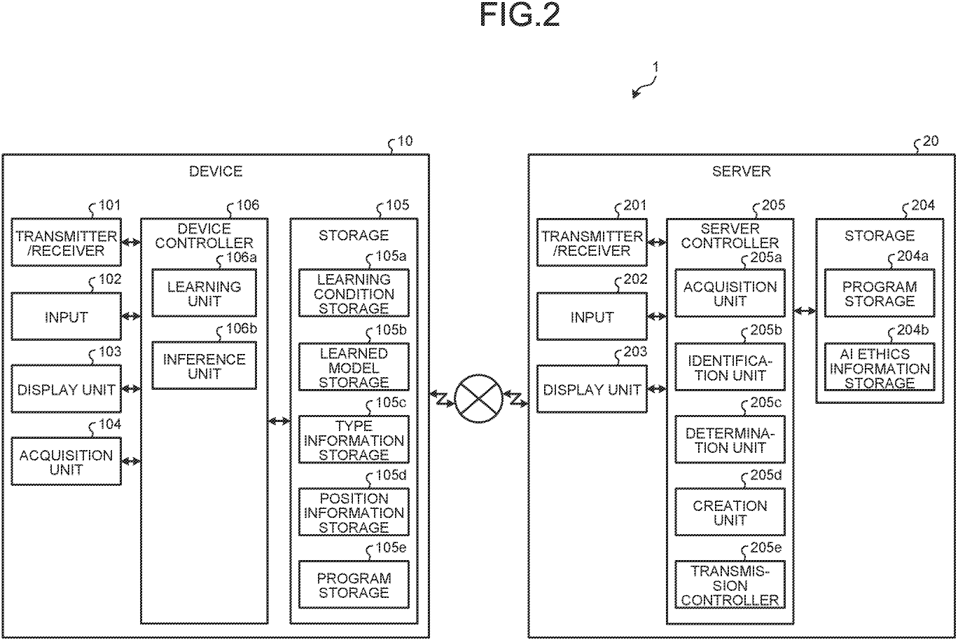

FIG. 1 illustrates a schematic configuration of the AI ethics compliance confirmation system according to one embodiment. FIG. 2 is a block diagram illustrating a functional configuration of the AI ethics compliance confirmation system according to one embodiment. An AI ethics compliance confirmation system 1 in FIGS. 1 and 2 includes a plurality of devices 10₁ to 10ₙ (n = integer of 5 or more) (hereinafter, when any of the plurality of devices 10₁ to 10ₙ is referred to, the device is simply written as a “device 10”) and a server 20. The server 20 can communicate with the plurality of devices 10₁ to 10ₙ via a network NW. The network NW includes, for example, an internet network and a mobile phone network.

### Functional Configuration of Device

First, a functional configuration of the device 10 will be described.

As illustrated in FIGS. 1 and 2, the device 10 is assumed to be a machine including AI in a server system, a PC such as a personal computer, a mobile phone, a tablet terminal device, a vehicle, a machine tool, and the like. The AI includes, for example, a learned model of a learning result obtained by deep learning, other machine learning, and the like. The device 10 includes a transmitter/receiver 101, a storage 105, a display unit 103, and a device controller 106.

The transmitter/receiver 101 transmits various pieces of information to the server 20 via the network NW and receives various pieces of information from the server 20 under the control of the device controller 106. The transmitter/receiver 101 includes a communication module and the like capable of transmitting/receiving various pieces of information.

An input 102 includes a keyboard, a mouse, a switch, a touch panel, and the like. The input 102 receives inputs of various operations of a user, and outputs information in response to the received operations to the device controller 106.

The display unit 103 displays various pieces of information on the device 10 under the control of the device controller 106. The display unit 103 includes a display such as a liquid crystal display and an organic electroluminescent (EL) display.

An acquisition unit 104 acquires predetermined data, and outputs the acquired data to the device controller 106. Here, the predetermined data is raw data necessary for generating a learned model including temperature data, humidity data, voice data, image data, text data, data of various parameters related to a vehicle, and the like. The acquisition unit 104 includes a sensor, a microphone, a complementary metal oxide semiconductor (CMOS) sensor, and an imaging device. The sensor detects various pieces of information on a vehicle and the like. The microphone acquires and generates voice data. The CMOS sensor images a subject, and generates image data. The imaging device includes a charge coupled device (CCD).

The storage 105 includes a dynamic random access memory (DRAM), a read only memory (ROM), a flash memory, a hard disk drive (HDD), a solid state drive (SSD), and the like. The storage 105 stores various pieces of information on the device 10. Furthermore, the storage 105 includes a learning condition storage 105a, a learned model storage 105b, a type information storage 105c, a position information storage 105d, and a program storage 105e. The learning condition storage 105a stores a learning condition of a learned model. The learned model storage 105b stores the learned model. The type information storage 105c stores a type of the learned model and information on a production company that created the learned model. The position information storage 105d stores the current position of the device 10. The program storage 105e stores a program executed by the device 10. Here, the learning condition includes a learning data set (teacher data), type information indicating a type of AI including a learned model and the like and a name of a vendor which created the learned model, a plurality of data groups including input data and output data input to the learned model as one set, an estimation target, and the like. Furthermore, the type of AI also includes types of image recognition, object detection, and the like, and types of an input parameter and an output parameter used for the types of image recognition, object detection, and the like. Furthermore, although a learned model of deep learning using a neural network will be described as a learned model in one example of the machine learning, machine learning based on other methods may be applied. For example, a learned model using other supervised learning such as a support vector machine, a decision tree, simple Bayes, and a k-nearest neighbor algorithm may be adopted as the learned model.

Furthermore, a learned model generated by semi-supervised learning or unsupervised learning instead of the supervised learning may be adopted as the learned model.

The device controller 106 includes a memory and a processor. The processor includes hardware such as a central processing unit (CPU), a field-programmable gate array (FPGA), and an application specific integrated circuit (ASIC). The device controller 106 controls each unit constituting the device 10. Furthermore, the device controller 106 reads and executes a program stored in the program storage 105e in a work area of a memory, and controls each component and the like through the execution of the program performed by the processor, so that hardware and software cooperate to implement a functional module that matches a predetermined object. Specifically, the device controller 106 includes a learning unit 106a and an inference unit 106b as functional modules. Note that, in one embodiment, the device controller 106 functions as a first processor.

The learning unit 106a generates a learned model by using the learning condition stored by the learning condition storage 105a, and stores the generated learned model in the learned model storage 105b. Specifically, the learning unit 106a generates the learned model by using the learning data set (supervised data) of the learning condition stored by the learning condition storage 105a and a known machine learning technique. Furthermore, the learning unit 106a may generate a learned model by learning various pieces of information acquired from at least one of the transmitter/receiver 101, the acquisition unit 104, and various sensors (not illustrated), for example, at least one of image data, voice data, and text data, as a learning data set of a learning condition. Of course, the learning unit 106a may cause the learned model stored by the learned model storage 105b to perform relearning or reinforcement learning by inputting predetermined data acquired by the acquisition unit 104 to the learned model as a learning data set (data set for unsupervised learning) of the learning condition. Note that the learning unit 106a may output a learned parameter (coefficient) of the learned model or the learned model to the outside.

The inference unit 106b inputs various pieces of information acquired from at least one of the transmitter/receiver 101, the acquisition unit 104, and various sensors (not illustrated), for example, at least one of image data, voice data, and text data as input parameters to a learned model stored by the learned model storage 105b by using the learned model, and outputs an output parameter of the learned model to the display unit 103 as an inference result.

### Functional Configuration of Server

Next, the functional configuration of the server 20 will be described.

As illustrated in FIGS. 1 and 2, a transmitter/receiver 201, an input 202, a display unit 203, a storage 204, and a server controller 205 are provided.

The transmitter/receiver 201 transmits various pieces of information to each device 10 via the network NW and receives various pieces of information from each device 10 under the control of the server controller 205. The transmitter/receiver 201 includes a communication module and the like capable of transmitting/receiving various pieces of information.

The input 202 receives inputs of various user operations, and outputs information in response to the received various operations to the server controller 205. The input 202 includes a keyboard, a mouse, a touch panel, various switches, and the like.

The display unit 203 displays various pieces of information on the server 20 under the control of the server controller 205. The display unit 203 includes a liquid crystal display, an organic EL display, and the like.

The storage 204 includes a RAM, a ROM, a flash memory, an HDD, an SSD, and the like, and stores various pieces of information on the server 20. The storage 204 includes a program storage 204a and an AI ethics information storage 204b. The program storage 204a stores various programs executed by the server 20. The AI ethics information storage 204b stores AI ethics information on AI ethics of each country.

The server controller 205 includes a memory and a processor including hardware such as a CPU, FPGA, and an ASIC. The server controller 205 controls each unit constituting the server 20. The server controller 205 reads and executes a program stored in the program storage 204a in a work area of the memory, and controls each component and the like through the execution of the program performed by the processor, so that hardware and software cooperate to implement a functional module that matches a predetermined object. Specifically, the server controller 205 includes, as functional modules, an acquisition unit 205a, an identification unit 205b, a determination unit 205c, a creation unit 205d, and a transmission controller 205e. Note that, in one embodiment, the server controller 205 functions as a second processor.

The acquisition unit 205a acquires a learning condition and position information for the device 10 to newly generate the learned model via the transmitter/receiver 201 and the network NW.

The identification unit 205b identifies AI ethics that the learned model newly generated by the device 10 needs to satisfy based on the position information transmitted from the device 10 and AI ethics information stored by the AI ethics information storage 204b. Specifically, the identification unit 205b identifies AI ethics for a country in the position information transmitted from the device 10 from the AI ethics information stored by the AI ethics information storage 204b.

The determination unit 205c determines whether the learned model newly generated by the device 10 satisfies the AI ethics based on the AI ethics identified by the identification unit 205b and the learning condition transmitted from the device 10.

The creation unit 205d creates transmission information indicating that the learned model newly generated by the device 10 satisfies the AI ethics. Furthermore, the creation unit 205d creates transmission information indicating that the learned model newly generated by the device 10 does not satisfy the AI ethics.

The transmission controller 205e causes the transmitter/receiver 201 to transmit the transmission information created by the creation unit 205d to the device 10.

### Processing Sequence in Device 10 and Server 20

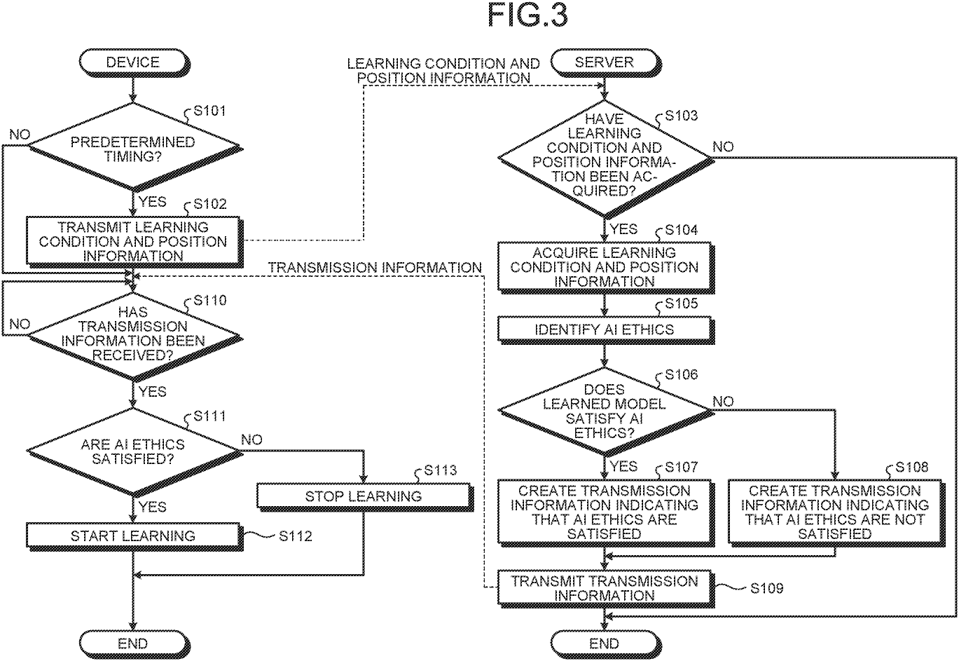

Next, a processing sequence in the device 10 and the server 20 will be described. FIG. 3 is a flowchart illustrating a processing sequence in the device 10 and the server 20. The processing sequence in FIG. 3 is repeatedly executed at a predetermined cycle, for example. Note that, although, in FIG. 3, in order to simplify the description, processing of interaction in cooperation between one device 10 and the server 20 will be described, similar processing is executed in each of other devices 10 similarly in cooperation with the server 20.

As illustrated in FIG. 3, first, the device controller 106 determines whether it is predetermined timing (Step S101). Here, the predetermined timing includes: timing when the learning unit 106a creates a learned model by using a learning data set (teacher data) which is a predetermined learning condition; timing when the device 10 acquires the learning data set; timing when the device 10 performs relearning for the learned model and creates a secondary model or a tertiary model; timing of changing the learned parameter (weighting data) of the learned model by using the learning data set; timing when the device 10 generates a learning data set (teacher data) from raw data; timing when the device 10 performs reinforcement learning by using the learned model and data acquired by the acquisition unit 104; and timing when the device 10 creates another learned model having the same performance by performing learning (distillation) using preliminarily created input data and output data output by inputting the preliminarily created input data to the learned model. Furthermore, the raw data is primarily acquired by the device 10, a user, a vendor, or the like. The raw data is subjected to conversion processing and treatment processing so as to be readable in the device 10 or a database. Moreover, the learning data set is secondarily treated data generated for facilitating analysis in a learning method, and obtained by performing conversion processing and treatment processing on raw data. At least one of preprocessing such as removal of a missing value and an outlier and processing of adding separate data such as label information (correct answer data) is performed on the learning data set. When the device controller 106 determines that it is the predetermined timing (Step S101: Yes), the device 10 proceeds to Step S102 to be described later. In contrast, when the device controller 106 determines that it is not the predetermined timing (Step S101: No), the device 10 proceeds to Step S110 to be described later.

In Step S102, the device controller 106 causes the transmitter/receiver 101 to transmit the learning condition stored by the learning condition storage 105a and the position information on the device 10. Here, the learning condition includes a learning data set (teacher data), raw data, type information indicating a type of AI including a learned model and the like and a name of a vendor which created the learned model, an estimation target of the learned model, and the like. Here, the type of AI also includes types of an input parameter and an output parameter used for image recognition, object detection, and the like. Furthermore, the position information includes a current location of the device 10, for example, a country and an address in which the device 10 is installed or used.

Subsequently, the determination unit 205c determines whether the transmitter/receiver 201 has received the learning condition and the position information from the device 10 (Step S103). When the determination unit 205c determines that the transmitter/receiver 201 has received the learning condition and the position information from the device 10 (Step S103: Yes), the server 20 proceeds to Step S104 to be described later. In contrast, when the determination unit 205c determines that the transmitter/receiver 201 has not acquired the learning condition and the position information from the device 10 (Step S103: No), the server 20 ends the processing of the sequence.

In Step S104, the acquisition unit 205a acquires the learning condition and the position information received by the transmitter/receiver 201 from the device 10.

Subsequently, the identification unit 205b identifies AI ethics that the learned model newly generated by the device 10 needs to satisfy based on the position information transmitted from the device 10 and AI ethics information stored by the AI ethics information storage 204b (Step S105). Specifically, the identification unit 205b identifies AI ethics for a country in the position information transmitted from the device 10 from the AI ethics information stored by the AI ethics information storage 204b.

Then, the determination unit 205c determines whether the learned model newly generated by the device 10 satisfies the AI ethics based on the AI ethics identified by the identification unit 205b and the learning condition transmitted from the device 10 (Step S106). Specifically, the determination unit 205c determines whether the learned model newly generated by the device 10 satisfies, for example, fairness, which is the first of three design ideas of fairness, accountability, and transparency (FAT) based on the AI ethics identified by the identification unit 205b and the learning condition transmitted from the device 10. FAT is AI ethics of a country identified by the identification unit 205b. More specifically, the determination unit 205c determines whether the learning condition transmitted from the device 10 adds contents prohibited by AI ethics of a country in which the device 10 is installed or a country in which the device 10 is used, for example, information related to privacy such as race, sex, domicile, age, educational background, ethnicity, and culture included in a parameter of input data, gives an unjust bias to output data, and outputs the output data. Note that the determination unit 205c may determine whether the learned model newly generated by the device 10 satisfies the AI ethics by determining whether the type of the learned model newly generated by the device 10 is prohibited by AI ethics of a country in which the device 10 is installed based on the learning condition transmitted from the device 10. Moreover, the determination unit 205c may determine whether the learned model newly generated by the device 10 satisfies the AI ethics by determining whether an input parameter to be input to the learned model newly generated by the device 10 is prohibited by AI ethics of a country in which the device 10 is installed or a country in which the device 10 is used, for example, related to privacy such as sex and annual income based on the learning condition transmitted from the device 10. Moreover, the determination unit 205c may determine whether the accountability of the second and the transparency of the third are satisfied as AI ethics other than the fairness of the first among the three design ideas of FAT based on the AI ethics identified by the identification unit 205b and the learning condition transmitted from the device 10. When the determination unit 205c determines that the learned model newly generated by the device 10 satisfies the AI ethics (Step S106: Yes), the server 20 proceeds to Step S107 to be described later. In contrast, when the determination unit 205c determines that the learned model newly generated by the device 10 does not satisfy the AI ethics (Step S106: No), the server 20 proceeds to Step S108 to be described later.

In Step S107, the creation unit 205d creates transmission information indicating that the learned model newly generated by the device 10 satisfies AI ethics. Specifically, the creation unit 205d creates transmission information indicating that the learned model newly generated by the device 10 satisfies the AI ethics and the learned model can be used without problems. After Step S107, the server 20 proceeds to Step S109 to be described later.

In Step S108, the creation unit 205d creates transmission information indicating that the learned model newly generated by the device 10 does not satisfy the AI ethics. Specifically, when the learned model newly generated by the device 10 does not satisfy the AI ethics and there is a problem, the creation unit 205d creates transmission information including at least one of a stop instruction and a correction instruction. The stop instruction is given to stop learning under a learning condition. The correction instruction is given to correct a parameter of the learning condition so that the learning condition satisfies the AI ethics and to perform learning. After Step S108, the server 20 proceeds to Step S109 to be described later.

In Step S109, the transmission controller 205e causes the transmitter/receiver 201 to transmit the transmission information created by the creation unit 205d to the device 10. After Step S109, the server 20 ends the processing of the sequence.

In Step S110, the device controller 106 determines whether the transmission information has been received from the server 20 via the transmitter/receiver 101. When the device controller 106 determines that the transmission information has been received from the server 20 via the transmitter/receiver 101 (Step S110: Yes), the device 10 proceeds to Step S111 to be described later. In contrast, when the device controller 106 determines that the transmission information has not been received from the server 20 via the transmitter/receiver 101 (Step S110: No), this determination is performed at predetermined time intervals.

In Step S111, the device controller 106 determines whether the learned model newly generated by the learning unit 106a satisfies the AI ethics based on the information on whether the newly generated learned model included in the transmission information satisfies the AI ethics. When the device controller 106 determines that the learned model newly generated by the learning unit 106a satisfies the AI ethics (Step S111: Yes), the device 10 proceeds to Step S112 to be described later. In contrast, when the device controller 106 determines that the learned model newly generated by the learning unit 106a does not satisfy the AI ethics (Step S111: No), the device 10 proceeds to Step S113 to be described later.

In Step S112, the learning unit 106a starts learning by using the learning condition stored by the learning condition storage 105a. In this case, the learning unit 106a generates a learned model by performing learning using the learning data set of the learning condition, and stores the learned model in the learned model storage 105b. After Step S112, the device 10 ends the processing of the sequence.

In Step S113, the learning unit 106a executes stop processing of stopping learning using the learning condition stored by the learning condition storage 105a. In this case, when the transmission information includes a correction instruction to correct a parameter of the learning condition and to perform learning, the learning unit 106a executes learning processing in which correction is performed so that a part of parameters in a learning data set of the learning condition satisfies the AI ethics, and learning is performed, and generates a learned model. Furthermore, when the transmission information includes an output instruction to output information indicating that the learning condition does not satisfy the AI ethics to a user scheduled to use the learned model, the device controller 106 executes output processing of causing the display unit 103 to display a warning indicating that the learning condition does not satisfy the AI ethics on the display unit 103. After Step S112, the device 10 ends the processing of the sequence.

According to above-described one embodiment, the server controller 205 acquires a learning condition for newly generating a learned model, identifies AI ethics that the learned model needs to satisfy, and determines whether the newly generated learned model satisfies the AI ethics based on the learning condition and the AI ethics, so that whether newly generated AI complies with the AI ethics can be determined.

Furthermore, in one embodiment, the above-described “unit” can be replaced with a “circuit” or the like. For example, the device controller can be replaced with a device control circuit.

Furthermore, a program to be executed by the device 10 and the server 20 according to one embodiment is provided after being stored in a computer-readable storage medium such as a CD-ROM, a flexible disk (FD), a CD-R, a digital versatile disk (DVD), a USB medium, and a flash memory as file data in an installable format or an executable format.

Furthermore, the program to be executed by the device 10 and the server 20 according to one embodiment may be provided by being stored in a computer connected to a network such as the Internet and downloaded via the network.

Note that, although, in the description of the flowcharts in the present specification, the context of processing between steps is clearly indicated by using expressions such as “first”, “then”, and “subsequently”, the order of processing necessary for implementing the embodiment is not uniquely determined by these expressions. That is, the order of processing in the flowcharts described in the present specification can be changed as long as no contradiction occurs.

Further effects and variations can be easily derived by those skilled in the art. The broader aspects of the present disclosure are not limited to the particular details and the representative embodiment illustrated and described above. Therefore, various modifications can be made without departing from the spirit or scope of the general inventive concept defined by the appended claims and equivalents thereof.

According to the present disclosure, an effect of enabling determination of whether newly generated AI complies with AI ethics is obtained.

According to an embodiment, since a processor identifies AI ethics for a place where a learned model is used, the processor can determine whether the learned model satisfies the AI ethics in a place where the learned model is used.

According to an embodiment, since the processor identifies AI ethics for a place where a learned model is used, the processor can determine whether the learned model satisfies the AI ethics for each place where the learned model is used.

According to an embodiment, when the processor determines that the learned model does not satisfy the AI ethics, the processor outputs at least one of a stop instruction, an output instruction, and a correction instruction. The stop instruction is given to stop learning under a learning condition. The output instruction is given to output information indicating that the learning condition does not satisfy the AI ethics. The correction instruction is given to correct a parameter of the learning condition so that the learning condition satisfies the AI ethics and to perform learning. The processor can thus cause a device that generates the learned model to execute at least one of processing of stopping generation of the learned model, processing of outputting information indicating that the learned model does not satisfy the AI ethics, and correction processing of correcting the learning condition to satisfy the AI ethics.

According to an embodiment, since the learning condition is transmitted to the server at the timing when the first processor generates the learned model, generation of a learned model that does not satisfy the AI ethics can be prevented.

According to an embodiment, since the first processor executes one or more of stop processing, output processing, and learning processing. Generation of the learned model is stopped in the stop processing. Information indicating that the learning condition does not satisfy the AI ethics is output on a display in the output processing. A correction is performed so that a part of parameters in a learning data set of the learning condition satisfies the AI ethics, and learning is performed in the learning processing. Generation of the learned model that does not satisfy the AI ethics can thus be prevented.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A server comprising a processor that:
acquires a learning condition for newly generating a learned model;
identifies AI ethics that the learned model needs to satisfy; and
determines whether the learned model newly generated satisfies the AI ethics based on the learning condition and the AI ethics.

2. The server according to claim 1,
wherein the processor identifies the AI ethics for a place where the learned model is used.

3. The server according to claim 2,
wherein the processor:
acquires position information on a place where a device that stores the learned model is used and AI ethics information on AI ethics for each country; and
identifies the AI ethics based on the position information and the AI ethics information.

4. The server according to claim 1,
wherein, when determining that the learned model does not satisfy the AI ethics, the processor outputs at least one of a stop instruction to stop learning under the learning condition, an output instruction to output information indicating that the learning condition does not satisfy the AI ethics on a display, and a correction instruction to correct a parameter of the learning condition so that the learning condition satisfies the AI ethics and to perform learning.

5. An AI ethics compliance confirmation system comprising:
a device including a first processor that generates a learned model based on a learning condition; and
a server that communicates with the device,
wherein the server includes a second processor that:
acquires the learning condition;
identifies AI ethics that the learned model needs to satisfy; and
determines whether the learned model newly generated satisfies the AI ethics based on the learning condition and the AI ethics.

6. The AI ethics compliance confirmation system according to claim 5,
wherein the first processor transmits the learning condition to the server at timing when the learned model is generated.

7. The AI ethics compliance confirmation system according to claim 5,
wherein, when receiving transmission information indicating that the learned model newly generated does not satisfy the AI ethics from the server, the first processor executes one or more of stop processing of stopping learning under the learning condition, output processing of outputting information indicating that the learning condition does not satisfy the AI ethics on a display, and learning processing in which correction is performed so that a part of parameters in a learning data set of the learning condition satisfies the AI ethics, and learning is performed.

8. A non-transitory computer-readable recording medium storing a program causing a processor to execute:
acquiring a learning condition for newly generating a learned model;
identifying AI ethics that the learned model needs to satisfy; and
determining whether the learned model newly generated satisfies the AI ethics based on the learning condition and the AI ethics.
